(19) United States
(12) Patent Application Publication
(10) Pub. No.: US 2019/0034866 A1
(43) Pub. Date: Jan. 31, 2019

(54) METHOD AND DEVICE FOR GENERATING LOGISTICS DISTRIBUTION NETWORK

(71) Applicant: CAINIAO SMART LOGISTICS HOLDING LIMITED, GRAND CAYMAN (KY)

(72) Inventors: SHUPENG LI, HANGZHOU (CN); YUAN WANG, HANGZHOU (CN); YUEYANG CHEN, HANGZHOU (CN); TAO WANG, HANGZHOU (CN)

(21) Appl. No.: 16/145,557

(22) Filed: Sep. 28, 2018

Related U.S. Application Data
(63) Continuation of application No. PCT/CN2017/077242, filed on Mar. 20, 2017.

(30) Foreign Application Priority Data
Apr. 1, 2016 (CN) 201610204711.X

(51) Int. Cl. G06Q 10/08

(52) U.S. Cl. CPC G06Q 10/087

(57) ABSTRACT

Embodiments of the present application provide a method and device for generating a logistics distribution network. The method includes: determining, by a supply-chain collaboration server, an expected sales range of a transaction object; determining, according to corresponding relationships between identifiers of warehouses and coverage ranges of distribution services of the warehouses obtained from logistics provider servers, identifiers of selectable warehouses of which corresponding coverage ranges of distribution services jointly cover the expected sales range of the transaction object; and generating a logistics distribution network for the transaction object according to the identifiers of the selectable warehouses and the corresponding coverage ranges of the distribution services of the selectable warehouses, the logistics distribution network having the selectable warehouses as nodes and distribution paths between the selectable warehouses as routes.

### CROSS-REFERENCE TO RELATED APPLICATIONS

This application is a continuation application of International Patent Application No. PCT/CN2017/077242, filed on Mar. 20, 2017, which claims priority to Chinese Patent Application No. 201610204711.X, filed with the Chinese Patent Office on Apr. 1, 2016 and entitled “METHOD AND DEVICE FOR GENERATING LOGISTICS DISTRIBUTION NETWORK.” The above referenced applications are incorporated herein by reference in their entirety.

### TECHNICAL FIELD

The present application relates to Internet information processing, and in particular, to a method and device for generating a logistics distribution network.

### BACKGROUND

In an existing replenishment network, a logistics distribution network between a production base and warehouses is known, and replenishment among the warehouses are mainly performed according to the following modes:

Mode 1: The warehouses are independent of each other. The production base directly delivers goods to the terminal warehouses. In this mode, replenishment operates simply, and may be directly performed according to demands.

Mode 2: The warehouses have different levels, and multi-level replenishment is performed. The base first replenishes the inventory in a parent warehouse, and the inventory then flows level by level to a terminal warehouse. In this mode, costs and efficiency are fully considered. Trunk line transportation may be used for a parent warehouse, and common logistics may be used for a terminal warehouse. Moreover, replenishment frequency may be flexibly adjusted and configured for warehouses of different levels, so that costs are further reduced.

Mode 3: The warehouses have different levels, and the base can replenish the inventory in a warehouse of any level. Compared with Mode 2, Mode 3 is more flexible. In Mode 3, a warehouse that has an urgent need and requires high efficiency can be directly replenished, and other warehouses can be replenished based on levels by using an existing warehouse network.

Given that the warehouses belong to logistics providers, the foregoing three logistics modes can only be used among internal warehouses of logistics providers. Each logistics provider can only control respective logistics resources. Therefore, logistics resource information of respective logistics providers cannot be centrally controlled.

### SUMMARY

The present application provides a method for generating a logistics distribution network, so as to resolve the problem that logistics resource information of respective logistics providers cannot be centrally controlled.

A method for generating a logistics distribution network may comprise:

determining, by a supply-chain collaboration server, an expected sales range of a transaction object;

determining, according to corresponding relationships between identifiers of warehouses and coverage ranges of distribution services of the warehouses obtained from logistics provider servers, identifiers of selectable warehouses of which corresponding coverage ranges of distribution services jointly cover the expected sales range of the transaction object; and

generating a logistics distribution network for the transaction object according to the identifiers of the selectable warehouses and the corresponding coverage ranges of the distribution services of the selectable warehouses, the logistics distribution network having the selectable warehouses as nodes and distribution paths between the selectable warehouses as routes.

In some embodiments, the determining, by a supply-chain collaboration server, of an expected sales range of a transaction object may comprise: receiving, by the supply-chain collaboration server, an expected sales range of the transaction object sent by a supplier terminal; and determining the received expected sales range as the expected sales range of the transaction object.

In some embodiments, the coverage ranges of distribution services may comprise: coverage ranges of dispatch services and coverage ranges of collection and transfer services. The determining, according to the corresponding relationships between identifiers of warehouses and coverage ranges of distribution services of the warehouses obtained from the logistics provider servers, identifiers of selectable warehouses of which corresponding coverage ranges of distribution services jointly cover the expected sales range of the transaction object may comprise: selecting, according to the corresponding relationships between identifiers of warehouses and coverage ranges of distribution services of the warehouses obtained from the logistics provider servers, identifiers of first selectable warehouses of which corresponding coverage ranges of dispatch services jointly cover the expected sales range of the transaction object; determining identifiers of second selectable warehouses of which corresponding coverage ranges of collection and transfer services jointly cover physical addresses of the first selectable warehouses represented by the identifiers of the first selectable warehouses; and using the determined identifiers of the first selectable warehouses and the determined identifiers of the second selectable warehouses as the identifiers of the selectable warehouses of which the corresponding coverage ranges of the distribution services jointly cover the expected sales range of the transaction object.

In some embodiments, the generating of a logistics distribution network for the transaction object according to the identifiers of the selectable warehouses and the corresponding coverage ranges of the distribution services of the selectable warehouse may comprise: using the identifiers of the first selectable warehouses which do not correspond to coverage ranges of collection and transfer services as identifiers of terminal warehouses, wherein the terminal warehouses are linked to users purchasing the transaction object; selecting a preset quantity of identifiers from the identifiers of the second selectable warehouses according to a production address of the transaction object, and using the preset quantity of identifiers as identifiers of base warehouses, wherein the base warehouses are linked to a production base of the transaction object; determining, for each selectable warehouse among the selectable warehouses other than the terminal warehouses and the base warehouses, a parent warehouse and a child warehouse of the selectable warehouse according to a geographical location of the selectable warehouse, wherein the transaction object sequentially flows through the parent warehouse of the selectable warehouse, the selectable warehouse, and the child warehouse of the selectable warehouse during logistics transportation; and connecting the each selectable warehouse and the parent warehouse and the child warehouse of the selectable warehouse, to form the logistics distribution network for the transaction object, wherein the logistics distribution network is a directed acyclic network.

In some embodiments, after the connecting of the each selectable warehouse and the parent warehouse and the child warehouse of the selectable warehouse, to form the logistics distribution network for the transaction object, the method may further comprise: for each selectable warehouse having a plurality of parent warehouses, determining, according to logistics transportation capabilities of the plurality of parent warehouses of the selectable warehouse, replenishment proportions for replenishing the inventory of the selectable warehouse by the plurality of parent warehouses; determining stock demand quantities of the warehouses in the logistics distribution network according to replenishment demand quantities and the replenishment proportions of the warehouses for replenishing their child warehouses, wherein the stock demand quantity of each of the warehouses comprises a replenishment demand quantity of the warehouse and stock quantities supplied by the warehouse for its child warehouses; generating logistics task messages of the warehouses in the logistics distribution network by using the determined stock demand quantities of the warehouses and the logistics distribution network, wherein each of the logistics task messages comprises: an identifier of a warehouse, a replenishment demand quantity of the warehouse, a stock demand quantity of the warehouse, and information about a parent warehouse and information about a child warehouse of the warehouse; and delivering the determined logistics task messages to corresponding logistics provider servers.

In some embodiments, the determining of the stock demand quantities of the warehouses in the logistics distribution network according to the replenishment demand quantities and the replenishment proportions of the warehouses for replenishing their child warehouses may comprise: performing the following operations for each warehouse in each level of the warehouses in the logistics distribution network, level by level, starting from an upper-level warehouse of a terminal warehouse, until a base warehouse is reached: determining a replenishment demand quantity of the warehouse; determining a stock demand quantity of a child warehouse of the warehouse and a replenishment proportion for replenishing the inventory of the child warehouse by the warehouse, wherein a stock demand quantity of a terminal warehouse is a replenishment demand quantity of the terminal warehouse; determining a stock quantity that the warehouse supplies to the child warehouse by using the determined stock demand quantity of the child warehouse and the determined replenishment proportion for replenishing the inventory of the child warehouse by the warehouse; and using a sum of the replenishment demand quantity of the warehouse and the stock quantity that the warehouse supplies to the child warehouse as a stock demand quantity of the warehouse.

A method for generating a logistics distribution network may comprise:

determining, by a logistics provider server, corresponding relationships between identifiers of warehouses of logistics providers and coverage ranges of distribution services of the warehouses, and

sending the determined corresponding relationships between identifiers of warehouses and coverage ranges of distribution services of the warehouses to a supply-chain collaboration server, the corresponding relationship configured to be used by the supply-chain collaboration server to generate a logistics distribution network for a transaction object.

In some embodiments, the method for generating a logistics distribution may further comprise: receiving a logistics task message delivered by the supply-chain collaboration server, wherein the logistics task message comprises: an identifier of a warehouse, a replenishment demand quantity of the warehouse, a stock demand quantity of the warehouse, and information about a parent warehouse and information about a child warehouse of the warehouse.

A supply-chain collaboration server may comprise: one or more processors; and a memory storing instructions that, when executed by the one or more processor, cause the server to perform:

determining an expected sales range of a transaction object:

determining, according to corresponding relationships between identifiers of warehouses and coverage ranges of distribution services of the warehouses obtained from logistics provider servers, identifiers of selectable warehouses of which corresponding coverage ranges of distribution services jointly cover the expected sales range of the transaction object; and

generating a logistics distribution network for the transaction object according to the identifiers of the selectable warehouses and the corresponding coverage ranges of the distribution services of the selectable warehouses, the logistics distribution network having the selectable warehouses as nodes and distribution paths between the selectable warehouses as routes.

The present application have the following beneficial effects. A supply-chain collaboration server is introduced in the embodiments of the present application. The supply-chain collaboration server may communicate with logistics provider servers, obtain corresponding relationships between identifiers of warehouses and coverage ranges of distribution services of the warehouses from the logistics provider servers, and customize, according to an expected sales range of a transaction object, a corresponding logistics distribution network for the transaction object. Subsequently, logistics information of the transaction object can be processed and practical logistics operations can be performed based on the generated logistics distribution network, achieving integration and central control of logistics resource information of logistics providers based on the expected sales range of the transaction object.

### BRIEF DESCRIPTION OF THE DRAWINGS

To describe the technical solutions of the embodiments of the present application more clearly, the following briefly introduces the accompanying drawings required for describing the embodiments. Apparently, the accompanying drawings in the following description show only some embodiments of the present application, and a person of ordinary skill in the art may still derive other drawings from these accompanying drawings without creative efforts.

FIG. 1 is a schematic structural diagram of a system for generating a logistics distribution network according to an embodiment of the present application:

FIG. 2 is a first schematic flowchart of a method for generating a logistics distribution network according to an embodiment of the present application:

FIG. 3 is a schematic diagram of relationships between a warehouse, its parent warehouses and child warehouses according to an embodiment of the present application;

FIG. 4 is a schematic diagram of a logistics distribution network of a transaction object according to an embodiment of the present application;

FIG. 5 is a schematic diagram of replenishment proportions for warehouses according to an embodiment of the present application:

FIG. 6 is a schematic diagram of replenishment demand quantities of warehouses according to an embodiment of the present application;

FIG. 7 is a schematic diagram of stock demand quantities of warehouses according to an embodiment of the present application:

FIG. 8 is a second schematic flowchart of a method for generating a logistics distribution network according to an embodiment of the present application;

FIG. 9 is a schematic structural diagram of a supply-chain collaboration server according to an embodiment of the present application; and

FIG. 10 is a schematic structural diagram of a logistics provider server according to an embodiment of the present application.

### DETAILED DESCRIPTION OF THE INVENTION

Embodiments of the present application provide a method and device for generating a logistics distribution network. In the method, a supply-chain collaboration server connects logistics provider servers, to obtain logistics resource information of logistics providers. The logistics resource information herein may include corresponding relationships between identifiers of warehouses and coverage ranges of distribution services of the warehouses. The supply-chain collaboration server may acquire other resource information from the logistics provider servers according to an actual demand. In some embodiments, after an expected sales range of a transaction object is acquired, the obtained logistics resource information is used to determine selectable warehouses of which corresponding coverage ranges of distribution services jointly cover the expected sales range, and a logistics distribution network is generated for the transaction object. Subsequently, logistics information of the transaction object can be processed and practical logistics operations can be performed based on the generated logistics distribution network, achieving integration and central control of logistics resources of the logistics providers, allowing logistics services not to be limited to one logistics provider, and saving logistics expenses for the transaction object.

A system for generating a logistics distribution network that can implement the embodiments of the present application is described below.

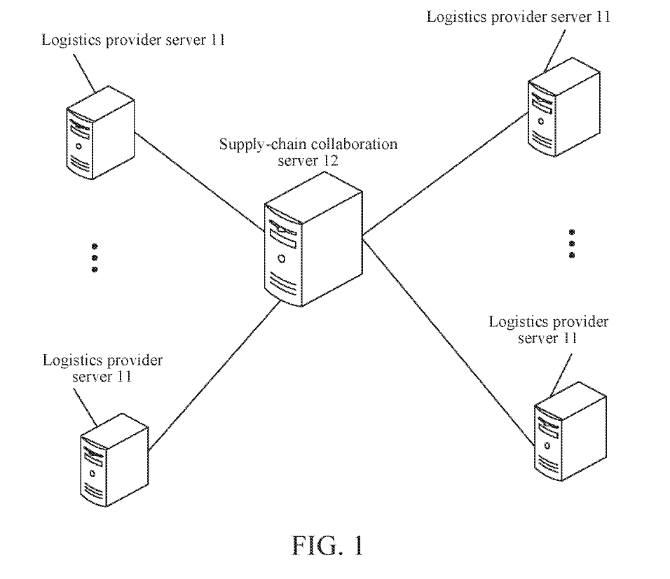

FIG. 1 is a schematic structural diagram of a system for generating a logistics distribution network according to an embodiment of the present application. As shown in FIG. 1, the system includes at least two logistics provider servers 11 and a supply-chain collaboration server 12.

Each logistics provider server 11 is configured to: store logistics resource information of logistics providers, the logistics resource information including: corresponding relationships between identifiers of warehouses and coverage ranges of distribution services of the warehouses; and send the logistics resource information to the supply-chain collaboration server 12.

The supply-chain collaboration server 12 is configured to: obtain the logistics resource information of the logistics providers from the logistics provider servers 11, determine an expected sales range of a transaction object; determine, according to the obtained logistics resource information, identifiers of selectable warehouses of which corresponding coverage ranges of distribution services jointly cover the expected sales range; and generate a logistics distribution network for the transaction object according to the identifiers of the selectable warehouses and the corresponding coverage ranges of the distribution services of the selectable warehouses. The logistics distribution network have the selectable warehouses as nodes and distribution paths between the selectable warehouses as routes.

The following describes the embodiments of the present application in further detail with reference to the accompanying drawings in the embodiments in the specification. Apparently, the described embodiments are some of the embodiments of the present application rather than all of the embodiments. All other embodiments obtained by a person of ordinary skill in the art based on the embodiments of the present application without creative efforts shall fall within the protection scope of the present application.

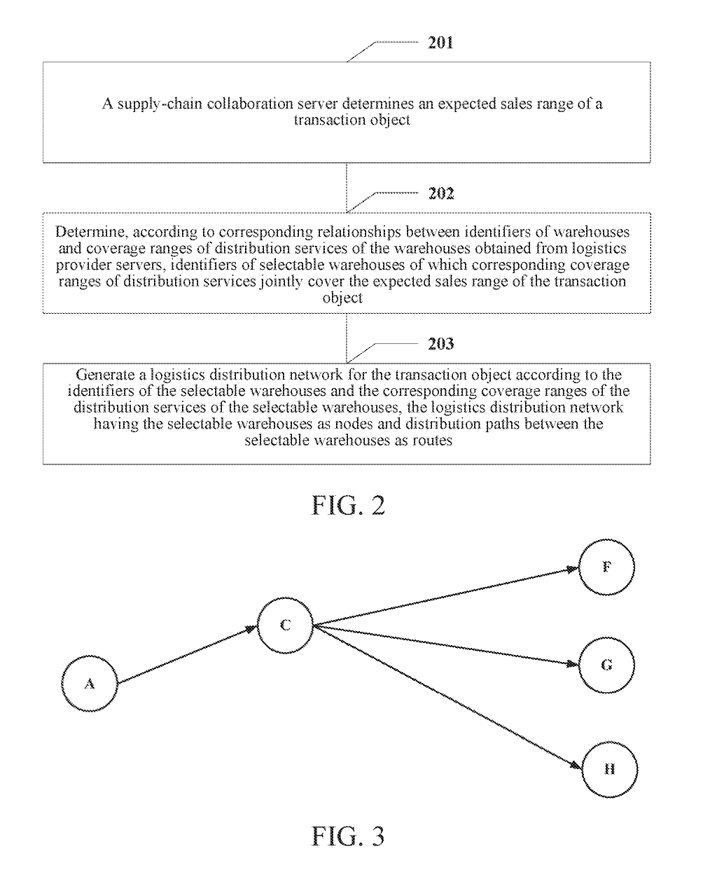

FIG. 2 is a schematic flowchart of a method for generating a logistics distribution network according to an embodiment of the present application. As shown in FIG. 2, the method may include the following steps.

Step 201: A supply-chain collaboration server determines an expected sales range of a transaction object.

The expected sales range of the transaction object may be set in advance according to a sales demand of a supplier, a distributor or an agent. For example, the expected sales range of the transaction object may be central China, China, Asia or the like.

In some embodiments, the expected sales range of the transaction object may be determined in the following manner:

receiving, by the supply-chain collaboration server, an expected sales range of the transaction object sent by a supplier terminal; and

determining the received expected sales range as the expected sales range of the transaction object.

Step 202: Determine, according to corresponding relationships between identifiers of warehouses and coverage ranges of distribution services of the warehouses obtained from logistics provider servers, identifiers of selectable warehouses of which corresponding coverage ranges of distribution services jointly cover the expected sales range.

In some embodiments, a logistics provider server stores logistics resource information. The logistics resource information includes the foregoing corresponding relationships between identifiers of warehouses and coverage ranges of distribution services of the warehouses, and physical locations and warehouse capacity information of the warehouses.

As described above, the coverage ranges of distribution services of the selectable warehouses jointly cover the expected sales range. Therefore, selectable warehouses represented by the determined identifiers of selectable warehouses can ensure that the transaction object flows directly or flows level by level from a supplier to a terminal warehouse.

The distribution service includes a dispatch service and a collection and transfer service. After the coverage ranges of the distribution services of the warehouses are obtained, a plurality of warehouses may be selected based on the condition of satisfying an expected coverage range of the transaction object. For example, a combination of coverage ranges of the plurality of warehouses can completely cover the expected sales range. The coverage ranges of the multiple warehouses may overlap.

Every warehouse has some distribution function. Some warehouses may have a collection and transfer function, and transaction objects may be gathered in such warehouses and transferred from such warehouses to other warehouses in an area. Some warehouses may have a dispatch function, and a transaction object may be delivered from such a warehouse to a user in a range. Some warehouses have both a collection and transfer function and a dispatch function. In some embodiments, a coverage range of a distribution service is used to represent these functions of the warehouses herein. A coverage range of a distribution service corresponding to the warehouse that only has a collection and transfer function refers to a coverage range of a collection and transfer service. A coverage range of a distribution service corresponding to the warehouse that only has a dispatch function refers to a coverage range of a dispatch service. A coverage range of a distribution service corresponding to the warehouse that has both a collection and transfer function and a dispatch function refers to a coverage range of a dispatch service and a coverage range of a collection and transfer service.

In some embodiments, step 202 may be implemented by using the following steps.

First step: Select, according to the corresponding relationships between identifiers of warehouses and coverage ranges of distribution services of the warehouses obtained from the logistics provider servers, identifiers of first selectable warehouses of which corresponding coverage ranges of dispatch services jointly cover the expected sales range.

In an expected sales range, a transaction object may be delivered by a warehouse to a ship-to address specified by a user. Therefore, the identifiers of the first selectable warehouses of which corresponding coverage ranges of dispatch services jointly cover the expected sales range may to be selected herein.

As indicated above, the selected first selectable warehouses have a dispatch function. In some embodiments, the first selectable warehouses may be the warehouses that have both a dispatch service function and a collection and transfer service function. Therefore, the first selectable warehouses have both a coverage range of a dispatch service and a coverage range of a collection and transfer service.

Assume that in the foregoing step 201, the transaction object is an air conditioner and the expected sales range is China, the obtained coverage ranges of distribution services of a warehouse A through a warehouse I are shown in Table 1.

TABLE 1

| | Coverage Range of | Coverage Range of |
|---|---|---|
| Identifier of | Dispatch Service of | Collection and Transfer |
| Warehouse | Warehouse | Service of Warehouse |
| A | NULL | East China, South Central China, |
| | | Southwest China |
| B | NULL | Southwest China, North China |
| C | Northwest China | East China, South Central China, |
| | | Southwest China |
| D | NULL | Southwest China |
| E | Northeast China | North China |
| F | East China | NULL |
| G | South Central China | NULL |
| H | Southwest China | NULL |
| I | North China | NULL |

Based on Table 1, the determined identifiers of the first selectable warehouses are C, E, F, G, H, and I. The warehouse C and the warehouse E herein both correspond to a coverage range of a dispatch service and a coverage range of a collection and transfer service.

Second step: Determine identifiers of second selectable warehouses of which corresponding coverage ranges of collection and transfer services jointly cover physical addresses of the first selectable warehouses represented by the identifiers of the first selectable warehouses.

By using the foregoing first step, a transaction object can be successfully delivered to a ship-to address specified by a user. However, how the transaction object flows to the first selectable warehouses, directly or level by level, may further depend on the warehouses that have a collection and transfer service function. Therefore, in the second step, the warehouses that have a collection and transfer service function may be selected, and coverage ranges of the selected warehouses that have a collection and transfer service function cover physical addresses of the foregoing first selectable warehouses, so that transaction objects can flow from the warehouses that have a collection and transfer function to the first selectable warehouses that have a dispatch function.

In some embodiments, some warehouses have both a dispatch function and a collection and transfer function. Therefore, the first selectable warehouses selected in the foregoing first step and the second selectable warehouses selected in the second step may overlap.

In some embodiments, the identifiers of the first selectable warehouses and identifiers of the second selectable warehouses may be from different logistics provider servers, that is, the first selectable warehouses and second selectable warehouses may belong to different logistics providers.

Following the foregoing example, and based on the foregoing Table 1, the determined identifiers of the second selectable warehouses are A, B, C, D, and E. The identifiers C and E of the second selectable warehouses and C and E of the first selectable warehouses overlap.

Third step: Use the determined identifiers of the first selectable warehouses and the determined identifiers of the second selectable warehouses as the identifiers of the selectable warehouses of which the corresponding coverage ranges of the distribution services jointly cover the expected sales range.

Following the foregoing example, the determined identifiers of the selectable warehouses are A, B, C, D, E, F, G, H, and I.

Step 203: Generate a logistics distribution network for the transaction object according to the identifiers of the selectable warehouses and the corresponding coverage ranges of the distribution services of the selectable warehouses, the logistics distribution network having the selectable warehouses as nodes and distribution paths between the selectable warehouses as routes.

The identifiers of the selectable warehouses are obtained, and the coverage ranges of the distribution services of the selectable warehouses can jointly cover the expected sales range of the transaction object. Therefore, transportation paths between the selectable warehouses may be determined with reference to the coverage ranges, and the transportation paths between the selectable warehouses are used to generate the logistics distribution network for the transaction object.

In some embodiments, the foregoing step 203 may be implemented via the following step 1) to step 4):

Step 1): Use the identifiers of the first selectable warehouses which do not correspond to coverage ranges of collection and transfer services as identifiers of terminal warehouses, where the terminal warehouses are linked to the users purchasing the transaction object;

In some embodiments, the link between the terminal warehouses and the users means that a transaction object in the terminal warehouses may be directly distributed to the users without any intermediate warehouses.

Following the example in Table 1, the identifiers C and E may be removed, the identifiers F, G, H, and I may be obtained as identifiers of terminal warehouses.

Step 2): Select a preset quantity of identifiers from the identifiers of the second selectable warehouses according to a production address of the transaction object, and use the preset quantity of identifiers as identifiers of base warehouses, where the base warehouses are linked to a production base of the transaction object.

In some embodiments, to facilitate the transportation of a transaction object from a production address to a base warehouse, the production address of the transaction object is used as a reference herein to select identifiers of the second selectable warehouses whose distances from the production base of the transaction object, transportation costs, and transportation duration satisfy constraint conditions, and use the selected identifiers of the second selectable warehouses as the identifiers of the base warehouses.

Following the example in Table 1, assume that the warehouse A and the warehouse B satisfy a constraint condition herein, then the warehouses A and B may be selected and used as the identifiers of the base warehouses.

Step 3): Determine, for each selectable warehouse among the selectable warehouses other than the terminal warehouses and the base warehouses, a parent warehouse and a child warehouse of the selectable warehouse according to a geographical location of the selectable warehouse, where the transaction object sequentially flows through the parent warehouse of the selectable warehouse, the selectable warehouse, and the child warehouse of the selectable warehouse during logistics transportation.

Following the example in Table 1, the warehouse C, the warehouse D, and the warehouse E are the selectable warehouses herein. FIG. 3 shows level relationships between the warehouse C and the parent warehouses and child warehouses. As shown in FIG. 3, the warehouse A is a parent warehouse of the warehouse C, and the warehouse F, the warehouse G, and the warehouse H are child warehouses of the warehouse C.

In addition, with respect the other selectable warehouses D, E, the warehouse B is a parent warehouse of the warehouse D, and the warehouse H is a child warehouse of the warehouse D. The warehouse B is also a parent warehouse of the warehouse E, and the warehouse I is a child warehouse of the warehouse E.

Step 4): Connect the each selectable warehouse and the parent warehouse and the child warehouse of the each selectable warehouse, to form the logistics distribution network for the transaction object, where the logistics distribution network is a directed acyclic network.

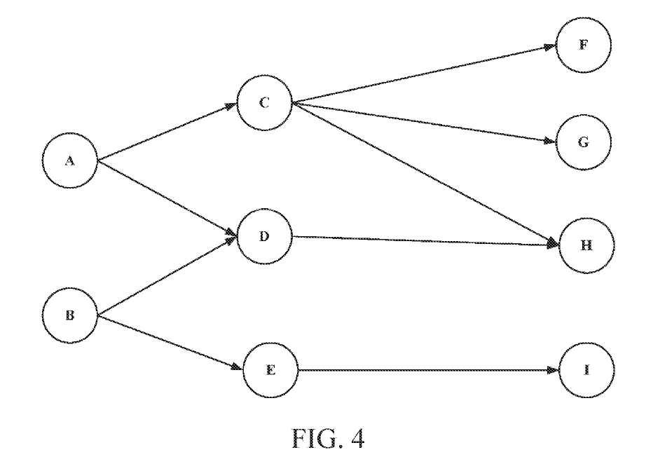

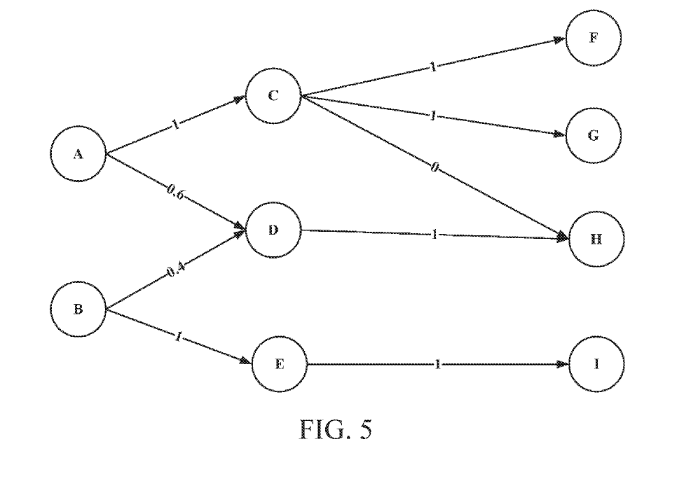

In some embodiments, a logistics distribution network generated for air conditioners is shown in FIG. 4. As shown in FIG. 4, the selectable warehouses C, D, E, their parent warehouses A. B, and child warehouses F, G, H, I are connected respectively according to their relationships as described above. For example, the selectable warehouse C is connected with its parent warehouse A, and its child warehouses F, G, H. The selectable warehouse D is connected with its parent warehouses A, B, and its child warehouse H. Similarly, the selectable warehouse E is connected with its parent warehouse B, and its child warehouse I.

After the logistics distribution network is generated, the logistics distribution network may be used to process logistics information. A process of the processing may include the following step A to step D:

Step A: for each selectable warehouse having a plurality of parent warehouses, determine, according to logistics transportation capabilities of the plurality of parent warehouses of the selectable warehouse, replenishment proportions for replenishing the inventory of the selectable warehouse by the plurality of parent warehouses.

In some embodiments, if logistics transportation capabilities of the parent warehouses are higher, it is determined that the replenishment proportions for replenishing the inventory of the selectable warehouse by the parent warehouses are higher. In addition, capacity information of the warehouses may further be used in combination with the transportation capabilities to determine the replenishment proportions for replenishing the inventory of the selectable warehouse by the parent warehouses. The replenishment proportions determined in the foregoing step A may be shown in FIG. 5.

FIG. 5 is a schematic diagram of replenishment proportions for warehouses according to an embodiment of the present application. As shown in FIG. 5, for the selectable warehouse D which has two parent warehouses A, B, the determined replenishment proportions from parent A is 0.6, and the replenishment proportions from parent B is 0.4.

Step B: Determine stock demand quantities of the warehouses in the logistics distribution network according to replenishment demand quantities and the replenishment proportions of the warehouses for replenishing their child warehouses, where the stock demand quantity of each of the warehouses includes a replenishment demand quantity of the warehouse and stock quantities supplied by the warehouse for its child warehouses.

In some embodiments, step B herein may include the following step B1 to step B5:

Step B1: Perform the following step B2 to step B5 for each warehouse in each level of the warehouses in the logistics distribution network, level by level, starting from an upper-level warehouse of a terminal warehouse, until a base warehouse is reached:

Step B2: Determine a replenishment demand quantity of the warehouse.

Step B3: Determine a stock demand quantity of a child warehouse of the warehouse and a replenishment proportion for replenishing the inventory of the child warehouse by the warehouse, where a stock demand quantity of a terminal warehouse is a replenishment demand quantity of the terminal warehouse.

Step B4: Determine a stock quantity that the warehouse supplies to the child warehouse by using the determined stock demand quantity of the child warehouse and the determined replenishment proportion for replenishing the inventory of the child warehouse by the warehouse.

Step B5: Use a sum of the replenishment demand quantity of the warehouse and the stock quantity that the warehouse supplies to the child warehouse as a stock demand quantity of the warehouse.

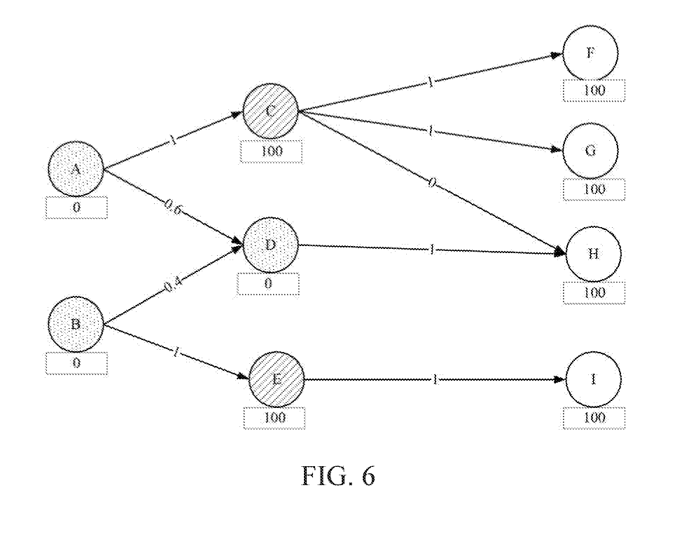

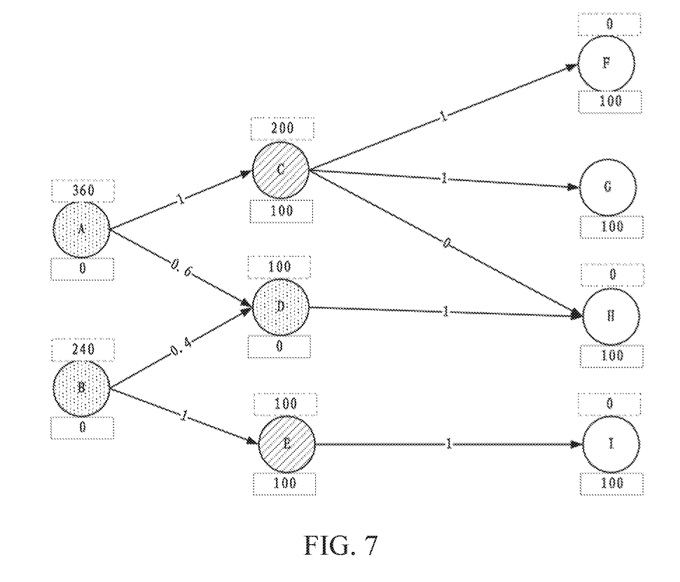

The foregoing process of step B1 to step B5 may be represented by using the schematic diagrams of the replenishment demand quantities shown in FIG. 6 and the stock demand quantities shown in FIG. 7.

Each of solid-line boxes in FIG. 6 represents a self-demand of a warehouse, that is, a replenishment demand quantity of the warehouse. For example, the warehouse F and the warehouse C have a dispatch capability and each has predicted sales of 100 pieces. The warehouse A and the warehouse D may not have stock and be used to fulfil a transfer and collection function. Each of dotted-line boxes in FIG. 7 represents a summed demand from the child warehouses of each warehouse. For example, the warehouse I does not have a child warehouse, the summed child demand is 0. A demand from the child warehouse I of the warehouse E is 100, and “100” is shown in the dotted-box associated with the warehouse E. A self-demand of the warehouse E is 100, as indicated by the number in the solid-line box associated with the warehouse E. Therefore, the demand of the warehouse E from the only parent warehouse B is 200. The warehouse B also provides a supply to the warehouse D. A self-demand of the warehouse D is 0. A summed demand of the child warehouses of the warehouse D is 100 (here, the warehouse D only has one child H requesting a stock of 100). Therefore, the total demand of the warehouse D is 100. The warehouse B may supply 40% of the 100-piece demand of the warehouse D (because the replenishment proportion from parent B to child D is 0.4), that is. B may supply 40 pieces to D. Therefore, the warehouse B may stock 240 pieces in total, given that B supplies 200 pieces to E.

Step C: Generate logistics task messages of the warehouses in the logistics distribution network by using the determined stock demand quantities of the warehouses and the logistics distribution network, where each of the logistics task messages includes: an identifier of a warehouse, a replenishment demand quantity of the warehouse, a stock demand quantity of the warehouse, and information about a parent warehouse and information about a child warehouse of the warehouse.

Step D: Deliver the determined logistics task messages to corresponding logistics provider servers.

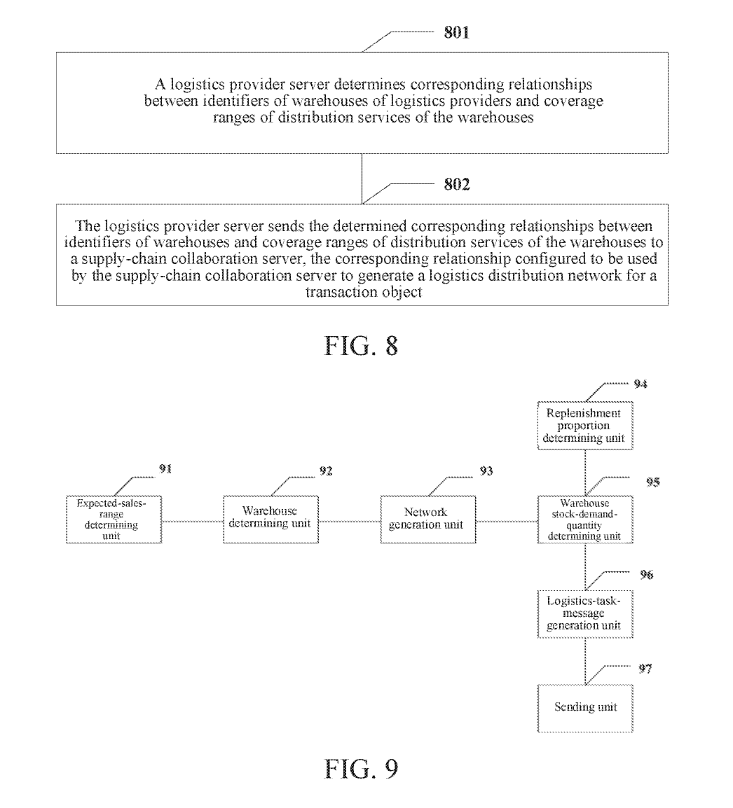

In the foregoing description, the method for generating a logistics distribution network according to this embodiment of the present application is described from the perspective of a supply-chain collaboration server. Further, an embodiment of the present application provides a method for generating a logistics distribution network from the perspective of a logistics provider server, as shown in the flowchart of FIG. 8. The method includes the following steps.

Step 801: The logistics provider server determines corresponding relationships between identifiers of warehouses of logistics providers and coverage ranges of distribution services of the warehouses.

Step 802: The logistics provider server sends the determined corresponding relationships between identifiers of warehouses and coverage ranges of distribution services of the warehouses to a supply-chain collaboration server, the corresponding relationship configured to be used by the supply-chain collaboration server to generate a logistics distribution network for a transaction object.

In addition, the logistics provider server may further receive a logistics task message delivered by the supply-chain collaboration server, where the logistics task message includes: an identifier of a warehouse, a replenishment demand quantity of the warehouse, a stock demand quantity of the warehouse, and information about a parent warehouse and information about a child warehouse of the warehouse.

The method for generating a logistics distribution network provided from the perspective of a logistics provider server may be essentially the same as the method for generating a logistics distribution network according to the embodiment of the present application described from the perspective of a supply-chain collaboration server. The difference may be the perspective of description. Refer to the foregoing description for related details, which are no longer elaborated herein.

Based on the same inventive concept, an embodiment of the present application further provides a supply-chain collaboration server and a logistics provider server.

FIG. 9 is a schematic structural diagram of the supply-chain collaboration server according to an embodiment of the present application. The supply-chain collaboration server includes:

an expected-sales-range determining unit 91, configured to determine an expected sales range of a transaction object;

a warehouse determining unit 92, configured to determine, according to corresponding relationships between identifiers of warehouses and coverage ranges of distribution services of the warehouses obtained from logistics provider servers, identifiers of selectable warehouses of which corresponding coverage ranges of distribution services jointly cover the expected sales range; and

a network generation unit 93, configured to generate a logistics distribution network for the transaction object according to the identifiers of the selectable warehouses and the corresponding coverage ranges of the distribution services of the selectable warehouses, the logistics distribution network having the selectable warehouses as nodes and distribution paths between the selectable warehouses as routes.

In some embodiments, the expected-sales-range determining unit 91 is configured to: receive an expected sales range of the transaction object sent by a supplier terminal; and determine the received expected sales range as the expected sales range of the transaction object.

In some embodiments, the coverage ranges of distribution services include: coverage ranges of dispatch services and coverage ranges of collection and transfer services; and

the warehouse determining unit 92 is configured to: select, according to the corresponding relationships between identifiers of warehouses and coverage ranges of distribution services of the warehouses obtained from the logistics provider servers, identifiers of first selectable warehouses of which corresponding coverage ranges of dispatch services jointly cover the expected sales range; determine identifiers of second selectable warehouses of which corresponding coverage ranges of collection and transfer services jointly cover physical addresses of the first selectable warehouses represented by the identifiers of the first selectable warehouses; and use the determined identifiers of the first selectable warehouses and the determined identifiers of the second selectable warehouses as the identifiers of the selectable warehouses of which the corresponding coverage ranges of the distribution services jointly cover the expected sales range.

In some embodiments, the network generation unit 93 is configured to: use the identifiers of the first selectable warehouses which do not correspond to coverage ranges of collection and transfer services as identifiers of terminal warehouses, where the terminal warehouses are linked to users purchasing the transaction object; select a preset quantity of identifiers from the identifiers of the second selectable warehouses according to a production address of the transaction object, and use the preset quantity of identifiers as identifiers of base warehouses, where the base warehouses are linked to a production base of the transaction object; determine, for each selectable warehouse among the selectable warehouses other than the terminal warehouses and the base warehouses, a parent warehouse and a child warehouse of the selectable warehouse according to a geographical location of the selectable warehouse, where the transaction object sequentially flows through the parent warehouse of the selectable warehouse, the selectable warehouse, and the child warehouse of the selectable warehouse during logistics transportation; and connect the each selectable warehouse and a parent warehouse and a child warehouse of the each selectable warehouse, to form the logistics distribution network for the transaction object, where the logistics distribution network is a directed acyclic network.

In some embodiments, the supply-chain collaboration server further includes:

a replenishment proportion determining unit 94, configured to, for each selectable warehouse having a plurality of parent warehouses, determine, according to logistics transportation capabilities of the plurality of parent warehouses of the selectable warehouse, replenishment proportions for replenishing the inventory of the selectable warehouse by the plurality of parent warehouses;

a warehouse stock-demand-quantity determining unit 95, configured to determine stock demand quantities of the warehouses according to replenishment demand quantities and the replenishment proportions of the warehouses, where the stock demand quantity of each of the warehouses includes a replenishment demand quantity of the warehouse and stock quantities supplied by the warehouse for its child warehouses;

a logistics-task-message generation unit 96, configured to generate logistics task messages for the warehouses by using the determined stock demand quantities of the warehouses and the logistics distribution network, where each of the logistics task messages includes: an identifier of a warehouse, a replenishment demand quantity of the warehouse, a stock demand quantity of the warehouse, and information about a parent warehouse and information about a child warehouse of the warehouse; and

a sending unit 97, configured to deliver the determined logistics task messages to corresponding logistics provider servers.

In some embodiments, the warehouse stock-demand-quantity determining unit 95 is configured to perform the following operations for each warehouse in each level, level by level, starting from an upper-level warehouse of a terminal warehouse, until a base warehouse is reached: determining a replenishment demand quantity of the warehouse; determining a stock demand quantity of a child warehouse of the warehouse and a replenishment proportion for replenishing the inventory of the child warehouse by the warehouse, where a stock demand quantity of a terminal warehouse is a replenishment demand quantity of the terminal warehouse; determining a stock quantity that the warehouse supplies to the child warehouse by using the determined stock demand quantity of the child warehouse and the determined replenishment proportion for replenishing the inventory of the child warehouse by the warehouse; and using a sum of the replenishment demand quantity of the warehouse and the stock quantity that the warehouse supplies to the child warehouse as a stock demand quantity of the warehouse.

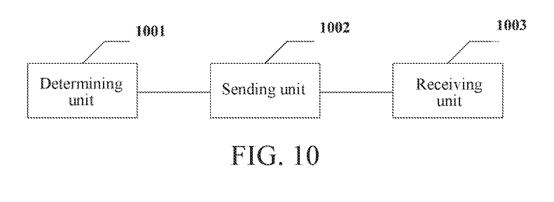

FIG. 10 is a schematic structural diagram of a logistics provider server according to an embodiment of the present application. The logistics provider server includes:

a determining unit 1001, configured to determine corresponding relationships between identifiers of warehouses of logistics providers and coverage ranges of distribution services; and

a sending unit 1002, configured to send the determined corresponding relationships between identifiers of warehouses and coverage ranges of distribution services of the warehouses to a supply-chain collaboration server, the corresponding relationship configured to be used by the supply-chain collaboration server to generate a logistics distribution network for a transaction object.

In some embodiments, the logistics provider server further includes:

a receiving unit 1003, configured to receive a logistics task message delivered by the supply-chain collaboration server, where the logistics task message includes: an identifier of a warehouse, a replenishment demand quantity of the warehouse, a stock demand quantity of the warehouse, and information about a parent warehouse and information about a child warehouse of the warehouse.

A person skilled in the art should understand that the embodiments of the present invention may be provided as a method, a device (apparatus), or a computer program product. Therefore, the present invention may use a form of a hardware embodiment, a software embodiment, or an embodiment combining software and hardware. In addition, the present invention may use a form of a computer program product implemented on one or more computer readable storage media (including but not limited to a disk memory, a CD-ROM, and an optical memory) including computer readable program code.

The present invention is described with reference to flowcharts and/or block diagrams of the method, the device (apparatus), and the computer program product in the embodiments of the present invention. It should be understood that computer program instructions can implement each process and/or block in the flowcharts and/or block diagrams and a combination of processes and/or blocks in the flowcharts and/or block diagrams. These computer program instructions may be provided to a general-purpose computer, an application-specific computer, an embedded processor, or a processor of another programmable data processing device to generate a machine, so that a device configured to implement functions specified in one or more processes in the flowcharts and/or one or more blocks in the block diagrams is generated by using instructions executed by the computer or the processor of another programmable data processing device. These computer program instructions may also be stored in a computer readable memory that can guide a computer or another programmable data processing device to work in a specific manner.

These computer program instructions may also be loaded into a computer or another programmable data processing device, so that a series of operation steps are performed on the computer or another programmable device to generate processing implemented by a computer, and instructions executed on the computer or another programmable device provide steps for implementing functions specified in one or more processes in the flowcharts and/or one or more blocks in the block diagrams.

Although preferred embodiments of the present invention are described, once acquiring basic innovative concepts, a person skilled in the art may make other changes and modifications to these embodiments. Therefore, the appended claims intend to be explained to include preferred embodiments and all changes and modifications that fall within scope of the present invention.

A person skilled in the art may make various modifications and variations to the present invention without departing from the spirit and scope of the present invention. In this way, if these modifications and variations to the present invention fall within the scope of claims of the present invention and equivalent technologies thereof, the present invention also intends to cover these modifications and variations.

What is claimed is:

1. A method for generating a logistics distribution network, comprising:
determining, by a supply-chain collaboration server, an expected sales range of a transaction object;
determining, according to corresponding relationships between identifiers of warehouses and coverage ranges of distribution services of the warehouses obtained from logistics provider servers, identifiers of selectable warehouses of which corresponding coverage ranges of distribution services jointly cover the expected sales range of the transaction object; and
generating a logistics distribution network for the transaction object according to the identifiers of the selectable warehouses and the corresponding coverage ranges of the distribution services of the selectable warehouses, the logistics distribution network having the selectable warehouses as nodes and distribution paths between the selectable warehouses as routes.

2. The method according to claim 1, wherein the determining, by a supply-chain collaboration server, of an expected sales range of a transaction object comprises:
receiving, by the supply-chain collaboration server, an expected sales range of the transaction object sent by a supplier terminal; and
determining the received expected sales range as the expected sales range of the transaction object.

3. The method according to claim 1, wherein the coverage ranges of distribution services comprise: coverage ranges of dispatch services and coverage ranges of collection and transfer services; and
the determining, according to the corresponding relationships between identifiers of warehouses and coverage ranges of distribution services of the warehouses obtained from the logistics provider servers, identifiers of selectable warehouses of which corresponding coverage ranges of distribution services jointly cover the expected sales range of the transaction object comprises:
selecting, according to the corresponding relationships between identifiers of warehouses and coverage ranges of distribution services of the warehouses obtained from the logistics provider servers, identifiers of first selectable warehouses of which corresponding coverage ranges of dispatch services jointly cover the expected sales range of the transaction object:
determining identifiers of second selectable warehouses of which corresponding coverage ranges of collection and transfer services jointly cover physical addresses of the first selectable warehouses represented by the identifiers of the first selectable warehouses; and
using the determined identifiers of the first selectable warehouses and the determined identifiers of the second selectable warehouses as the identifiers of the selectable warehouses of which the corresponding coverage ranges of the distribution services jointly cover the expected sales range of the transaction object.

4. The method according to claim 3, wherein the generating of a logistics distribution network for the transaction object according to the identifiers of the selectable warehouses and the corresponding coverage ranges of the distribution services of the selectable warehouse comprises:
using the identifiers of the first selectable warehouses which do not correspond to coverage ranges of collection and transfer services as identifiers of terminal warehouses, wherein the terminal warehouses are linked to users purchasing the transaction object;
selecting a preset quantity of identifiers from the identifiers of the second selectable warehouses according to a production address of the transaction object, and using the preset quantity of identifiers as identifiers of base warehouses, wherein the base warehouses are linked to a production base of the transaction object;
determining, for each selectable warehouse among the selectable warehouses other than the terminal warehouses and the base warehouses, a parent warehouse and a child warehouse of the selectable warehouse according to a geographical location of the selectable warehouse, wherein the transaction object sequentially flows through the parent warehouse of the selectable warehouse, the selectable warehouse, and the child warehouse of the selectable warehouse during logistics transportation; and
connecting the each selectable warehouse and the parent warehouse and the child warehouse of the selectable warehouse, to form the logistics distribution network for the transaction object, wherein the logistics distribution network is a directed acyclic network.

5. The method according to claim 4, wherein after the connecting of the each selectable warehouse and the parent warehouse and the child warehouse of the selectable warehouse, to form the logistics distribution network for the transaction object, the method further comprises:
for each selectable warehouse having a plurality of parent warehouses, determining, according to logistics transportation capabilities of the plurality of parent warehouses of the selectable warehouse, replenishment proportions for replenishing the inventory of the selectable warehouse by the plurality of parent warehouses;
determining stock demand quantities of the warehouses in the logistics distribution network according to replenishment demand quantities and the replenishment proportions of the warehouses for replenishing their child warehouses, wherein the stock demand quantity of each of the warehouses comprises a replenishment demand quantity of the warehouse and stock quantities supplied by the warehouse for its child warehouses,
generating logistics task messages of the warehouses in the logistics distribution network by using the determined stock demand quantities of the warehouses and the logistics distribution network, wherein each of the logistics task messages comprises: an identifier of a warehouse, a replenishment demand quantity of the warehouse, a stock demand quantity of the warehouse, and information about a parent warehouse and information about a child warehouse of the warehouse; and
delivering the determined logistics task messages to corresponding logistics provider servers.

6. The method according to claim 5, wherein the determining of the stock demand quantities of the warehouses in the logistics distribution network according to the replenishment demand quantities and the replenishment proportions of the warehouses for replenishing their child warehouses comprises:
performing the following operations for each warehouse in each level of the warehouses in the logistics distribution network, level by level, starting from an upper-level warehouse of a terminal warehouse, until a base warehouse is reached:
determining a replenishment demand quantity of the warehouse;
determining a stock demand quantity of a child warehouse of the warehouse and a replenishment proportion for replenishing the inventory of the child warehouse by the warehouse, wherein a stock demand quantity of a terminal warehouse is a replenishment demand quantity of the terminal warehouse;
determining a stock quantity that the warehouse supplies to the child warehouse by using the determined stock demand quantity of the child warehouse and the determined replenishment proportion for replenishing the inventory of the child warehouse by the warehouse; and
using a sum of the replenishment demand quantity of the warehouse and the stock quantity that the warehouse supplies to the child warehouse as a stock demand quantity of the warehouse.

7. A method for generating a logistics distribution network, comprising:
determining, by a logistics provider server, corresponding relationships between identifiers of warehouses of logistics providers and coverage ranges of distribution services of the warehouses; and
sending the determined corresponding relationships between identifiers of warehouses and coverage ranges of distribution services of the warehouses to a supply-chain collaboration server, the corresponding relationship configured to be used by the supply-chain collaboration server to generate a logistics distribution network for a transaction object.

8. The method according to claim 7, wherein the method further comprises:
receiving a logistics task message delivered by the supply-chain collaboration server, wherein the logistics task message comprises: an identifier of a warehouse, a replenishment demand quantity of the warehouse, a stock demand quantity of the warehouse, and information about a parent warehouse and information about a child warehouse of the warehouse.

9. A supply-chain collaboration server, comprising:
one or more processors; and
a memory storing instructions that, when executed by the one or more processors, cause the server to perform:
determining an expected sales range of a transaction object;
determining, according to corresponding relationships between identifiers of warehouses and coverage ranges of distribution services of the warehouses obtained from logistics provider servers, identifiers of selectable warehouses of which corresponding coverage ranges of distribution services jointly cover the expected sales range; and
generating a logistics distribution network for the transaction object according to the identifiers of the selectable warehouses and the corresponding coverage ranges of the distribution services of the selectable warehouses, the logistics distribution network having the selectable warehouses as nodes and distribution paths between the selectable warehouses as routes.

10. The supply-chain collaboration server according to claim 9, wherein the determining of an expected sales range of a transaction object comprises:
receiving an expected sales range of the transaction object sent by a supplier terminal; and
determining the received expected sales range as the expected sales range of the transaction object.

11. The supply-chain collaboration server according to claim 9, wherein the coverage ranges of distribution services comprise: coverage ranges of dispatch services and coverage ranges of collection and transfer services; and
the determining, according to the corresponding relationships between identifiers of warehouses and coverage ranges of distribution services of the warehouses obtained from the logistics provider servers, identifiers of selectable warehouses of which corresponding coverage ranges of distribution services jointly cover the expected sales range of the transaction object comprises:
selecting, according to the corresponding relationships between identifiers of warehouses and coverage ranges of distribution services of the warehouses obtained from the logistics provider servers, identifiers of first selectable warehouses of which corresponding coverage ranges of dispatch services jointly cover the expected sales range of the transaction object:
determining identifiers of second selectable warehouses of which corresponding coverage ranges of collection and transfer services jointly cover physical addresses of the first selectable warehouses represented by the identifiers of the first selectable warehouses; and
using the determined identifiers of the first selectable warehouses and the determined identifiers of the second selectable warehouses as the identifiers of the selectable warehouses of which the corresponding coverage ranges of the distribution services jointly cover the expected sales range of the transaction object.

12. The supply-chain collaboration server according to claim 11, wherein the generating of a logistics distribution network for the transaction object according to the identifiers of the selectable warehouses and the corresponding coverage ranges of the distribution services of the selectable warehouse comprises:
using the identifiers of the first selectable warehouses which do not correspond to coverage ranges of collection and transfer services as identifiers of terminal warehouses, wherein the terminal warehouses are linked to users purchasing the transaction object;
selecting a preset quantity of identifiers from the identifiers of the second selectable warehouses according to a production address of the transaction object, and using the preset quantity of identifiers as identifiers of base warehouses, wherein the base warehouses are linked to a production base of the transaction object;
determining, for each selectable warehouse among the selectable warehouses other than the terminal warehouses and the base warehouses, a parent warehouse and a child warehouse of the selectable warehouse according to a geographical location of the selectable warehouse, wherein the transaction object sequentially flows through the parent warehouse of the selectable warehouse, the selectable warehouse, and the child warehouse of the selectable warehouse during logistics transportation; and
connecting the each selectable warehouse and the parent warehouse and the child warehouse of the selectable warehouse, to form the logistics distribution network for the transaction object, wherein the logistics distribution network is a directed acyclic network.

13. The supply-chain collaboration server according to claim 12, wherein after the connecting of the each selectable warehouse and the parent warehouse and the child warehouse of the selectable warehouse, to form the logistics distribution network for the transaction object, the instructions, when executed by the one or more processors, further cause the server to perform:
for each selectable warehouse having a plurality of parent warehouses, determining, according to logistics transportation capabilities of the plurality of parent warehouses of the selectable warehouse, replenishment proportions for replenishing the inventory of the selectable warehouse by the plurality of parent warehouses;
determining stock demand quantities of the warehouses in the logistics distribution network according to replenishment demand quantities and the replenishment proportions of the warehouses for replenishing their child warehouses, wherein the stock demand quantity of each of the warehouses comprises a replenishment demand quantity of the warehouse and stock quantities supplied by the warehouse for its child warehouses,
generating logistics task messages of the warehouses in the logistics distribution network by using the determined stock demand quantities of the warehouses and the logistics distribution network, wherein each of the logistics task messages comprises: an identifier of a warehouse, a replenishment demand quantity of the warehouse, a stock demand quantity of the warehouse, and information about a parent warehouse and information about a child warehouse of the warehouse; and
delivering the determined logistics task messages to corresponding logistics provider servers.

14. The supply-chain collaboration server according to claim 13, wherein the determining of the stock demand quantities of the warehouses in the logistics distribution network according to the replenishment demand quantities and the replenishment proportions of the warehouses for replenishing their child warehouses comprises:
performing the following operations for each warehouse in each level of the warehouses in the logistics distribution network, level by level, starting from an upper-level warehouse of a terminal warehouse, until a base warehouse is reached:
determining a replenishment demand quantity of the warehouse;
determining a stock demand quantity of a child warehouse of the warehouse and a replenishment proportion for replenishing the inventory of the child warehouse by the warehouse, wherein a stock demand quantity of a terminal warehouse is a replenishment demand quantity of the terminal warehouse;
determining a stock quantity that the warehouse supplies to the child warehouse by using the determined stock demand quantity of the child warehouse and the determined replenishment proportion for replenishing the inventory of the child warehouse by the warehouse; and
using a sum of the replenishment demand quantity of the warehouse and the stock quantity that the warehouse supplies to the child warehouse as a stock demand quantity of the warehouse.
